(19) United States
(12) Patent Application Publication
(10) Pub. No.: US 2015/0039725 A1
(43) Pub. Date: Feb. 5, 2015

(54) APPARATUS AND METHODS FOR RESOLVING RESOURCE CONTENTION IN A CONTENT DISTRIBUTION NETWORK

(71) Applicant: Time Warner Cable Enterprises LLC, New York, NY (US)

(72) Inventors: Wesley George, New York, NY (US); Robert Seastrom, New York, NY (US)

(21) Appl. No.: 13/958,437

(22) Filed: Aug. 2, 2013

(51) Int. Cl. H04L 29/08

(52) U.S. Cl. CPC H04L 67/02
USPC 709/219

(57) ABSTRACT

Methods and apparatus for resolving resource contention in a content distribution network. In one embodiment, a manager entity at a subscriber premises manages requests for content from various subscriber devices in communication therewith. The manager identifies when there is a conflict, and implements a mechanism to resolve the conflict, such as by determining whether one or more conflicting content items may be provided according to an alternate delivery scheme. In one variant, the apparatus may further implement one or more rules for determining whether to adjust delivery of requested content. In another variant, the disclosed concepts may be utilized to provide efficient delivery of content, by providing alternate delivery prior when doing so would be more efficient than allowing for delivery at a first scheduled date/time. The system may take into account bandwidth or network constraints, whether other requests are pending (although there are still sufficient resources), etc.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Field of the Disclosure

The disclosure relates generally to the field of content and/or data delivery, such as via a content distribution (e.g., cable, satellite) or other network. In one exemplary aspect, the disclosure relates to the use of a network architecture for resolving resource contention during the delivery of content and/or data.

2. Description of Related Technology

Recent advances in content delivery technologies have led to the proliferation of different content sources carrying a wide variety of content. A viewer may be easily overwhelmed by the presentation of hundreds of broadcast channels, purchasable content channels (e.g., VOD, pay-per-view, etc.) and the like, offering programming 24 hours per day. With such an abundance of content offered, the user may be unable to rapidly and easily locate content of interest at any one time. In the alternative, the user may be confronted with multiple programs of interest, yet be left unable to view them all due to resource constraints (i.e., having a limited number of tuners available).

Likewise, other technological advancements have brought into common use electronic devices that allow users to record content received from a bearer network (such as a cable television or satellite network), whether at their premises or another location within the network. These devices include, inter alia, on digital video recorders (DVR), and personal video recorders (PVR). Access to content stored on recording devices further increases the overabundance of content available to the user, but does not solve the problem of a user not having enough tuners to watch and/or record all of the programs of interest to the user.

That is to say, DVR and other client devices have a limited number or size of tuner resources (such as QAM tuners). Thus, the number of programs that a user can watch and/or record simultaneously is limited. Currently, when a resource contention for tuners arises (e.g. the DVR has only 2 tuners and there are 3 programs scheduled to record, or there are 2 programs recording and the user wants to watch a third program, etc.), the DVR prompts the user to choose which programs to watch/record to resolve the resource contention. In other words, the user must choose between their selections, and one or more selections are not able to be recorded/watched.

Existing solutions to this problem generally involve adding additional tuners to the client devices (i.e., DVRs), so that a resource contention is less likely. However, this solution adds additional equipment cost, and does not resolve the problem for those existing users who are not in possession of the latest multi-tuner device. Another prior art solution provides client software that enables a user to prioritize different requests so that the client device in effect “knows” which events to preempt in the instance that a user is not available to make a decision manually. However, as with the previously discussed prior art solutions, this solution merely instructs the device to not record (or not enable viewing) of one or more requested programs, and does nothing to enable a user to view and/or record all of the programs of interest.

Hence, generally when a resource contention issue arises, users today must manually address the contention, or rely on previously configured priority settings to instruct the device to resolve the contention. In either instance, a user is simply unable to retain all of their selected recordings.

Therefore, what are needed are apparatus and methods for resolving resource contention in a content delivery network, Ideally, such apparatus and methods would not require or at least mitigate cancellation of delivery of one or more requested simultaneous events.

### SUMMARY

The present disclosure addresses the foregoing needs by providing, inter alia, apparatus and methods for resolving resource contention in a network, such as a content distribution (e.g., cable or satellite) network.

In a first aspect, a method of resolving resource contention is disclosed, In one embodiment, the contention resolution occurs within a user sub-system of a content delivery network, and the method includes: (i) receiving a request for content from a user, the content scheduled for delivery from the network at a first time, (ii) determining whether sufficient resources will be available in the user sub-system at the first time for to service the request, (iii) when it is determined that sufficient resources will not be available at the first time: identifying one or more second times at which the content is scheduled for delivery from the network, and enabling the request for the content at one of the one or more second times.

In a second aspect, an apparatus for resolving resource contention in a content delivery network is disclosed. In one embodiment, the apparatus includes a first interface configured to receive content from the content delivery network, a second interface configured to communicate with a plurality of subscriber devices, a storage apparatus, and a processor configured to execute at least one computer program, the computer program comprising a plurality of instructions. In one variant, the instructions are configured to, when executed: (i) receive a request for content from a first subscriber device, (ii) determine that the request conflicts with pending requests from other ones of the plurality of subscriber devices, and (iii) based at least in part on the determination, service at least one of the request and the pending requests at a second time. The second time is determined e.g., based at least in part on a schedule configured to indicate a repetition of delivery of the content within a pre-determined time window.

In a third aspect of the disclosure, a computer readable medium is disclosed. In one embodiment, the computer readable medium includes a plurality of instructions which are configured to, when executed: (i) receive a request for first content from a subscriber device, (ii) determine a date and time for a first scheduled delivery of the first content, (iii) determine a number of pending requests for second content at the date and time. In one variant, when it is determined that a number of resources necessary to service the request for the first content and the pending requests for the second content is greater than a number of resources available, a content delivery schedule is evaluated, the content delivery schedule indicating a plurality of dates and times for a second scheduled delivery of at least one of the first and the second content, and one of the plurality of dates and times for a second scheduled delivery of at least one of the first and second content is identified via the evaluation. An alternate delivery of at least one of the first and second content at the second scheduled delivery time is then enabled.

In a fourth aspect of the disclosure, a client device is disclosed. In one embodiment, the client device is configured to run a computer program thereon, the computer program having a plurality of instructions which are configured to, when executed, identify and resolve resource contention issues using at least an alternate delivery of one or more contending requests.

In a fifth aspect of the disclosure, a method for providing efficient delivery of content is disclosed. In one embodiment, the method includes: (i) receiving a resource request, (ii) determining adjustment alternatives, (iii) based on one or more rules, determining whether to proceed to adjust delivery of at least one request, (iv) when it is determined to proceed, adjust delivery of the at least one request, and (v) when it is determined not to proceed, and a conflict exists disallowing use of the requested resource, otherwise allowing use of the resource.

In a sixth aspect of the disclosure, a system for resolving resource contention in a user premises is disclosed. In one embodiment, the system includes a network content server configured to provide content from a content source to one or more devices in the user premises, a manager apparatus configured to manage the tuner resources of the user premises, and a plurality of tuner resource devices configured to receive requests for content from a plurality of users thereof, and service the requests based on communication received from the manager apparatus.

These and other aspects shall become apparent when considered in light of the disclosure provided herein.

### BRIEF DESCRIPTION OF THE DRAWINGS

FIG. 1 is a functional block diagram illustrating an exemplary hybrid fiber network configuration useful with the present disclosure.

FIG. 1a is a functional block diagram illustrating one exemplary network headend configuration useful with the present disclosure.

FIG. 1b is a functional block diagram illustrating one exemplary local service node configuration useful with the present disclosure.

FIG. 1c is a functional block diagram illustrating one exemplary broadcast switched architecture (BSA) network useful with the present disclosure.

FIG. 1d is a functional block diagram illustrating one exemplary packetized content delivery network architecture useful with the present disclosure.

FIG. 2 is a functional block diagram illustrating an exemplary embodiment of a content delivery network architecture configured in accordance with the present disclosure.

FIGS. 3a and 3b are block diagrams illustrating exemplary schedule for repeating content in accordance with one embodiment of the present disclosure.

FIG. 4a is a logical flow diagram illustrating an exemplary embodiment of a generalized method for resolving resource contention according to the present disclosure.

FIG. 4b is a logical flow diagram illustrating an exemplary embodiment of a generalized method for providing efficient delivery of content according to the present disclosure.

FIG. 5 is a functional block diagram illustrating one embodiment of a management device according to the present disclosure.

FIG. 6 is a functional block diagram illustrating an exemplary embodiment of a CPE according to the present disclosure.

All Figures © Copyright 2013 Time Warner Cable, Inc. All rights reserved.

### DETAILED DESCRIPTION

Reference is now made to the drawings wherein like numerals refer to like parts throughout.

As used herein, the term “application” refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the JavaTV™ environment.

As used herein, the term “client device” includes, but is not limited to, set-top boxes (e.g., DSTBs), gateways, modems, personal computers (PCs), and minicomputers, whether desktop, laptop, or otherwise, and mobile devices such as handheld computers, PDAs, personal media devices (PMDs), tablets, “phablets”, and smartphones.

As used herein, the term “codec” refers to a video, audio, or other data coding and/or decoding algorithm, process or apparatus including, without limitation, those of the MPEG (e.g., MPEG-1, MPEG-2, MPEG-4/H.264, etc.), Real (RealVideo, etc.), AC-3 (audio), DiVX, XViDNiDX, Windows Media Video (e.g., WMV 7, 8, 9, 10, or 11), ATI Video codec, or VC-1 (SMPTE standard 421M) families.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

The term “Customer Premises Equipment (CPE)” refers without limitation to any type of electronic equipment located within a customer's or user's premises and connected to or in communication with a network.

As used herein, the term “display” means any type of device adapted to display information, including without limitation CRTs, LCDs, TFTs, plasma displays, LEDs, incandescent and fluorescent devices, or combinations/integrations thereof. Display devices may also include less dynamic devices such as, for example, printers, e-ink devices, and the like.

As used herein, the term “DOCSIS” refers to any of the existing or planned variants of the Data Over Cable Services Interface Specification, including for example DOCSIS versions 1.0, 1.1, 2.0 and 3.0.

As used herein, the term “headend” refers generally to a networked system controlled by an operator (e.g., an MSO) that distributes programming to MSO clientele using client devices. Such programming may include literally any information source/receiver including, inter alia, free-to-air TV channels, pay TV channels, interactive TV, and the Internet.

As used herein, the terms “Internet” and “internet” are used interchangeably to refer to inter-networks including, without limitation, the Internet.

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the terms “MSO” or “multiple systems operator” refer to a cable, satellite, or terrestrial network provider having infrastructure required to deliver services including programming and data over those mediums.

As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the term “network interface” refers to any signal or data interface with a component or network including, without limitation, those of the FireWire (e.g., FW400, FW800, etc.), USB (e.g., USB2), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), Wi-Fi (802.11), WiMAX (802.16), PAN (e.g., 802.15), or IrDA families.

As used herein, the term “QAM” refers to modulation schemes used for sending signals over cable networks. Such modulation scheme might use any constellation level (e.g. QPSK, 16-QAM, 64-QAM, 256-QAM, etc.) depending on details of a cable network. A QAM may also refer to a physical channel modulated according to the schemes.

As used herein, the term “server” refers to any computerized component, system or entity regardless of form which is adapted to provide data, files, applications, content, or other services to one or more other devices or entities on a computer network.

As used herein, the term “storage” refers to without limitation computer hard drives, DVR device, memory, RAID devices or arrays, optical media (e.g., CD-ROMs, Laserdiscs, Blu-Ray, etc.), or any other devices or media capable of storing content or other information.

As used herein, the term “Wi-Fi” refers to, without limitation, any of the variants of IEEE-Std. 802.11 or related standards including e.g., 802.11a/b/g/i/n/v/z.

As used herein, the term “wireless” means any wireless signal, data, communication, or other interface including without limitation Wi-Fi, Bluetooth, 3G (3GPP/3GPP2), HSDPA/HSUPA, TDMA, CDMA (e.g., IS-95A, WCDMA, etc.), FHSS, DSSS, GSM, PAN/802.15, WiMAX (802.16), 802.20, Zigbee, narrowband/FDMA, OFDM, PCS/DCS, LTE/LTE-A, analog cellular, CDPD, satellite systems, millimeter wave or microwave systems, acoustic, and infrared (i.e., IrDA).

### Overview

The present disclosure provides, inter alia, methods and apparatus for resolving resource contention in a content distribution network. In one aspect, the present disclosure provides a manager entity (such as a gateway apparatus, or other client device) within a user or subscriber premises which is configured to receive and/or manage requests for content from various user/subscriber devices in communication therewith. The manager apparatus, by managing the content requests, is able to identify when there is a conflict; e.g., it can determine based on the number of tuner resources available in the subscriber premises, including all devices associated to the subscriber which are capable of receiving content, whether a particular request may be serviced (i.e., if there is an available tuner resource at a date and time of the requested content). When the apparatus determines that a conflict exists, it is further able to implement a mechanism (or cause another entity to implement a mechanism) to resolve the conflict by determining whether one or more of the conflicting content items are repeated during a given window.

The foregoing is accomplished in one implementation by consulting a content delivery schedule listing each program by program identification number (PAT). The manager apparatus may simply run a search of the PAT for the identified conflicting content to see whether it appears again in the schedule within a given time window.

In one variant, the apparatus may further implement one or more rules for determining whether to adjust delivery of requested content. For example, the manager may take into account information relating to the historical viewing patterns of the subscriber (such as how soon after recording commences is content generally viewed, and whether content is never or rarely viewed despite being recorded). Alternatively, the rules may be pre-determined by the network and/or entered manually by a user.

In another variant, the herein disclosed concepts may be utilized to provide efficient delivery of content, e.g., prior to the detection of an actual conflict, when it is known that an alternate delivery date/time are available, and doing so would be more efficient than allowing for delivery at a first scheduled date/time. The system may take into account bandwidth or network constraints, whether other requests are pending (although there are still sufficient resources), etc.

### DETAILED DESCRIPTION OF EXEMPLARY EMBODIMENTS

Exemplary embodiments of the apparatus and methods of the disclosure are now described in detail. While these exemplary embodiments are described in the context of the aforementioned hybrid fiber coax (HFC) cable system architecture having an multiple systems operator (MSO), digital networking capability, IP delivery capability, and plurality of client devices/CPE, the general principles and advantages of the present disclosure may be extended to other types of networks and architectures, whether broadband, narrowband, wired or wireless, managed or unmanaged, or otherwise, the following therefore being merely exemplary in nature. It will also be appreciated that while described generally in the context of a consumer (i.e., home) end user domain, the present disclosure may be readily adapted to other types of environments (e.g., commercial/enterprise, government/military, etc.) as well. Myriad other applications are possible.

Also, while certain aspects are described primarily in the context of the well-known Internet Protocol, it will be appreciated that the present disclosure may utilize other types of protocols (and in fact bearer networks to include other internets and intranets) to implement the described functionality.

Other features and advantages of the present disclosure will immediately be recognized by persons of ordinary skill in the art with reference to the attached drawings and detailed description of exemplary embodiments as given below.

### Network—

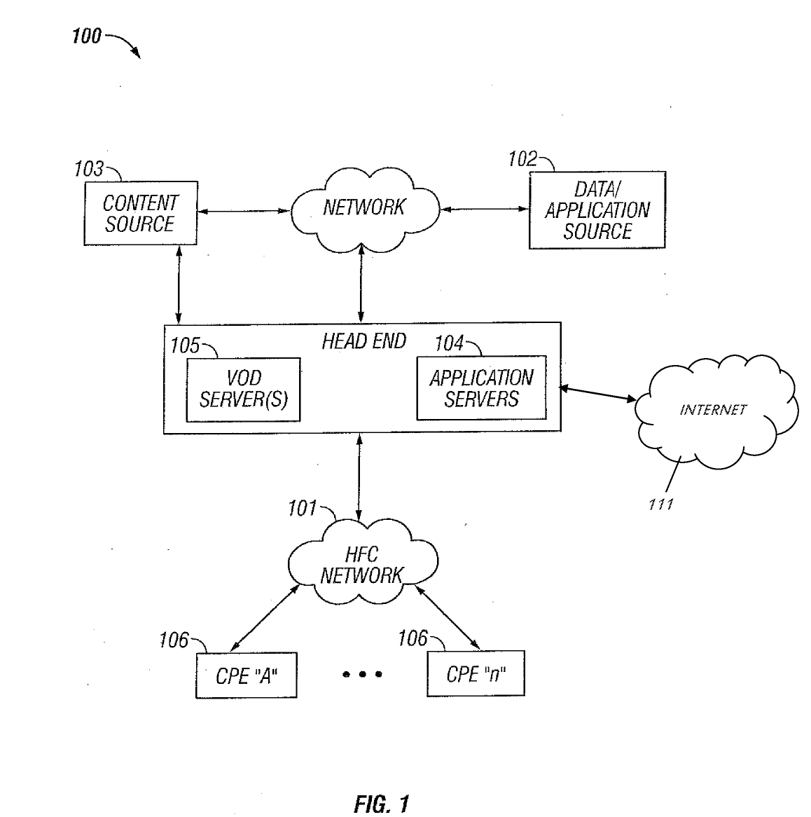

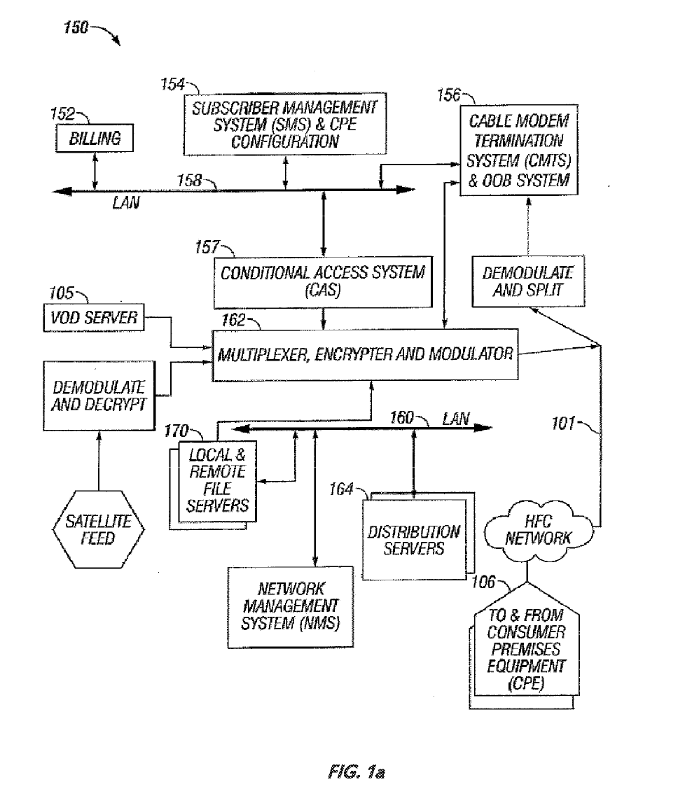

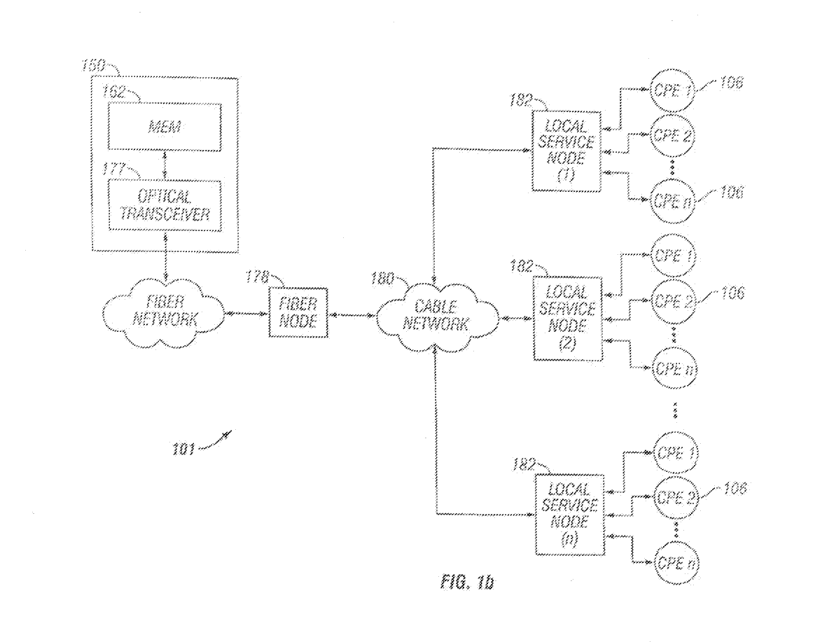

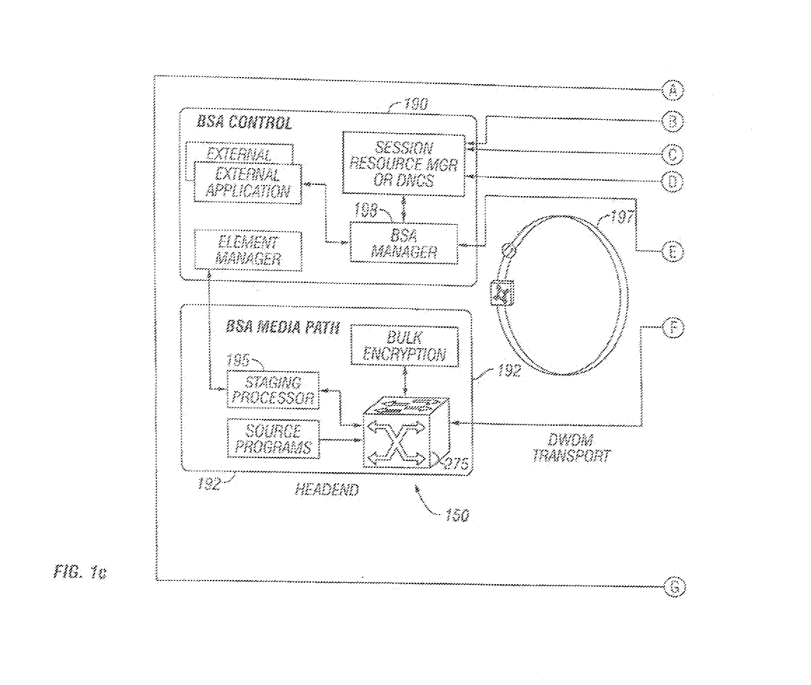

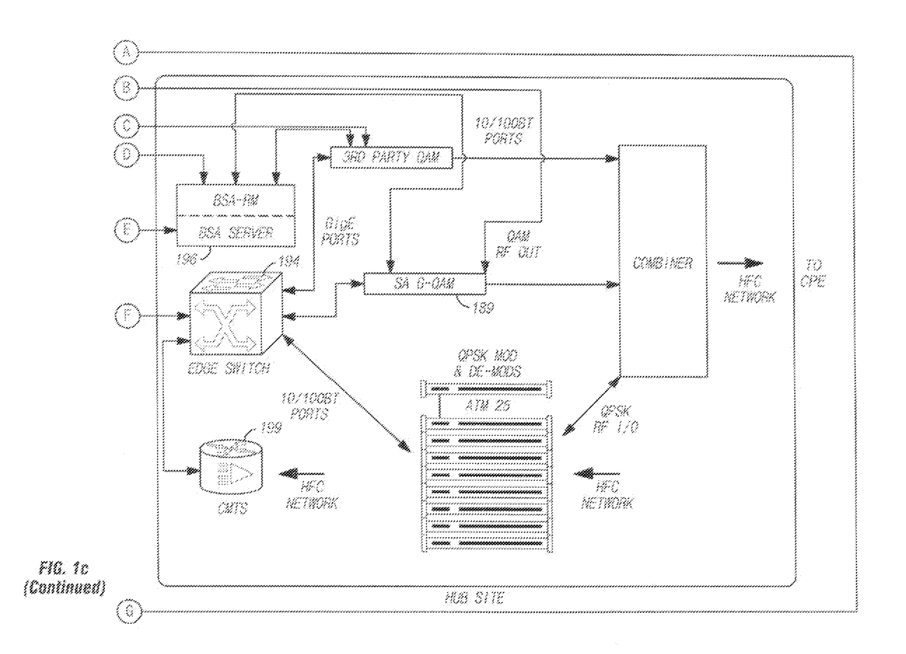

FIG. 1 illustrates a typical content delivery network configuration with which the exemplary apparatus and methods of the present disclosure may be used. The various components of the network 100 include (i) one or more data and application origination points 102; (ii) one or more content sources 103, (iii) one or more application distribution servers 104; (iv) one or more VOD servers 105, and (v) client devices or customer premises equipment (CPE) 106. The distribution server(s) 104, VOD servers 105 and CPE(s) 106 are connected via a bearer (e.g., HFC) network 101 (also referred to herein as a content delivery network (CDN)). The headend is also connected through a gateway or other such interface (not shown) to unmanaged external internetworks such as the Internet 111.

A simple architecture comprising one of each of the aforementioned components 102, 104, 105, 106 is shown in FIG. 1 for simplicity, although it will be recognized that comparable architectures with multiple origination points, distribution servers, VOD servers, and/or CPE devices (as well as different network topologies) may be utilized consistent with the disclosure. For example, the headend architecture of FIG. 1a (described in greater detail below) may be used.

The data/application origination point 102 comprises any medium that allows data and/or applications (such as a VOD-based or “Watch TV” application) to be transferred to a distribution server 104. This can include for example a third party data source, application vendor website, CD-ROM, external network interface, mass storage device (e.g., RAID system), etc. Such transference may be automatic, initiated upon the occurrence of one or more specified events (such as the receipt of a request packet or ACK), performed manually, or accomplished in any number of other modes readily recognized by those of ordinary skill.

The application distribution server 104 comprises a computer system where such applications can enter the network system. Distribution servers are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

The CPE 106 includes any equipment in the “customers' premises” (or other locations, whether local or remote to the distribution server 104) that can be accessed by a distribution server 104. As will be discussed in greater detail below, in one embodiment the CPE may include IP-enabled CPE 107 (although not illustrated in FIGS. 1-1d), and a gateway or specially configured modem (e.g., DOCSIS cable modem).

Referring now to FIG. 1a, one exemplary embodiment of a headend architecture useful with the present disclosure is described. As shown in FIG. 1a, the headend architecture 150 comprises typical headend components and services including billing module 152, subscriber management system (SMS) and CPE configuration management module 154, cable-modem termination system (CMTS) and OOB system 156, as well as LAN(s) 158, 160 placing the various components in data communication with one another. It will be appreciated that while a bar or bus LAN topology is illustrated, any number of other arrangements as previously referenced (e.g., ring, star, etc.) may be used consistent with the disclosure. It will also be appreciated that the headend configuration depicted in FIG. 1a is high-level, conceptual architecture and that each MSO may have multiple headends deployed using custom architectures.

The exemplary architecture 150 of FIG. 1a further includes a multiplexer-encrypter-modulator (MEM) 162 coupled to the HFC network 101 adapted to process or condition content for transmission over the network. The distribution servers 164 are coupled to the LAN 160, which provides access to the MEM 162 and network 101 via one or more file servers 170. The VOD servers 105 are coupled to the LAN 160 as well, although other architectures may be employed (such as for example where the VOD servers are associated with a core switching device such as an 802.3z Gigabit Ethernet device). As previously described, information is carried across multiple channels. Thus, the headend must be adapted to acquire the information for the carried channels from various sources. Typically, the channels being delivered from the headend 150 to the CPE 106 (“downstream”) are multiplexed together in the headend, as previously described and sent to neighborhood hubs (FIG. 1b) via a variety of interposed network components.

It will also be recognized, however, that the multiplexing operation(s) need not necessarily occur at the headend 150 (e.g., in the aforementioned MEM 162). For example, in one variant, at least a portion of the multiplexing is conducted at a BSA/SDV switching node or hub (see discussion of FIG. 1c provided subsequently herein). As yet another alternative, a multi-location or multi-stage approach can be used, such as that described in U.S. Pat. No. 7,602,820, entitled “APPARATUS AND METHODS FOR MULTI-STAGE MULTIPLEXING IN A NETWORK” incorporated herein by reference in its entirety, which discloses inter alia improved multiplexing apparatus and methods that allow such systems to dynamically compensate for content (e.g., advertisements, promotions, or other programs) that is inserted at a downstream network node such as a local hub, as well as “feed-back” and “feed forward” mechanisms for transferring information between multiplexing stages.

Content (e.g., audio, video, data, files, etc.) is provided in each downstream (in-band) channel associated with the relevant service group. To communicate with the headend or intermediary node (e.g., hub server), the CPE 106 may use the out-of-band (OOB) or DOCSIS channels and associated protocols. The OCAP 1.0 (and subsequent) specification provides for exemplary networking protocols both downstream and upstream, although the disclosure is in no way limited to these approaches.

It will also be recognized that the multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

An optical transport ring (not shown) is also commonly utilized to distribute the dense wave-division multiplexed (DWDM) optical signals to each hub within the network in an efficient fashion.

### “Switched” Networks—

FIG. 1c illustrates an exemplary “switched” network architecture. While a so-called “broadcast switched architecture” (BSA), also known as “switched digital video” or “SDV”, network is illustrated in this exemplary embodiment for performing bandwidth optimization/conservation functions, it will be recognized that the present disclosure is in no way limited to such architectures.

Switching architectures allow improved efficiency of bandwidth use for ordinary digital broadcast programs. Ideally, the subscriber will be unaware of any difference between programs delivered using a switched network and ordinary streaming broadcast delivery.

FIG. 1c shows the implementation details of one exemplary embodiment of this broadcast switched network architecture. Specifically, the headend 150 contains switched broadcast control and media path functions 190, 192; these elements cooperate to control and feed, respectively, downstream or edge switching devices 194 at the hub site which are used to selectively switch broadcast streams to various service groups. A BSA or SDV server 196 is also disposed at the hub site, and implements functions related to switching and bandwidth conservation (in conjunction with a management entity 198 disposed at the headend). An optical transport ring 197 is utilized to distribute the dense wave-division multiplexed (DWDM) optical signals to each hub in an efficient fashion.

U.S. patent application Ser. No. 09/956,688 entitled “TECHNIQUE FOR EFFECTIVELY PROVIDING PROGRAM MATERIAL IN A CABLE TELEVISION SYSTEM” describes one exemplary broadcast switched digital architecture useful with the present disclosure, although it will be recognized by those of ordinary skill that other approaches and architectures may be substituted.

A primary advantage of the BSA paradigm is bandwidth conservation/preservation. Bandwidth for unviewed programs is not consumed, and can be re-allocated. Similarly, new programs can be added without adding bandwidth. Advantageously, programs with narrow appeal can be added in a BSA system with little if any bandwidth impact. More popular programs will impact the BSA bandwidth, but to a lesser extent than was traditionally the case. Multiple bitrates can also be made available for use or sale to programmers or advertisers.

In one exemplary embodiment, the methods and apparatus of co-owned, co-pending U.S. patent application Ser. No. 12/841,906 filed on Jul. 22, 2010 and entitled “APPARATUS AND METHODS FOR PACKETIZED CONTENT DELIVERY OVER A BANDWIDTH-EFFICIENT NETWORK”, which is incorporated herein by reference in its entirety, may be utilized. As discussed therein, packetized content is provided to subscribers of an MSO network via extant bandwidth-optimized network infrastructure. In one embodiment, various legacy and IP-capable user devices receive a list of available content, from which a user may select. The user's selection is transmitted to an intermediary device or proxy (such as gateway apparatus in the home, or a headend server) which formats the request according to a standardized protocol utilized by a server (e.g., the BSA/SDV server of FIG. 1c) for providing bandwidth-optimized delivery of content. The server uses one or more bandwidth optimization techniques to provide the requested content to the proxy. If the content is requested by an IP-capable device, the proxy formats the content using protocol translation. The formatted content is then delivered to the requesting IP-capable CPE. However, if the content is requested from a legacy device (e.g., a non-IP enabled STB), protocol translation is not necessary. In this manner, IP and legacy CPE can be freely intermixed in any proportion in the service group and home, the gateway or headend proxy being configured to deliver content regardless of the requesting device.

### Packetized Content Delivery Network—

While the foregoing network architectures described herein can (and in fact do) carry packetized content (e.g., IP over MPEG for high-speed data or Internet TV, MPEG2 packet content over QAM for MPTS, etc.), they are often not optimized for such delivery. Hence, in accordance with another embodiment, a “packet optimized” delivery network is used for carriage of the packet content (e.g., IPTV content). FIG. 1d illustrates one exemplary implementation of such a network, in the context of a 3GPP IMS (IP Multimedia Subsystem) network with common control plane and service delivery platform (SDP), as described in U.S. Patent Application Publication No. 2011/0103374 filed on Apr. 21, 2010, and entitled “METHODS AND APPARATUS FOR PACKETIZED CONTENT DELIVERY OVER A CONTENT DELIVERY NETWORK”, incorporated herein by reference in its entirety. Such a network provides significant enhancements in terms of common control of different services, implementation and management of content delivery sessions according to unicast or multicast models, etc.; however, it is appreciated that the various features of the present disclosure are in no way limited to any of the foregoing architectures.

### Resource Contention Network Architecture—

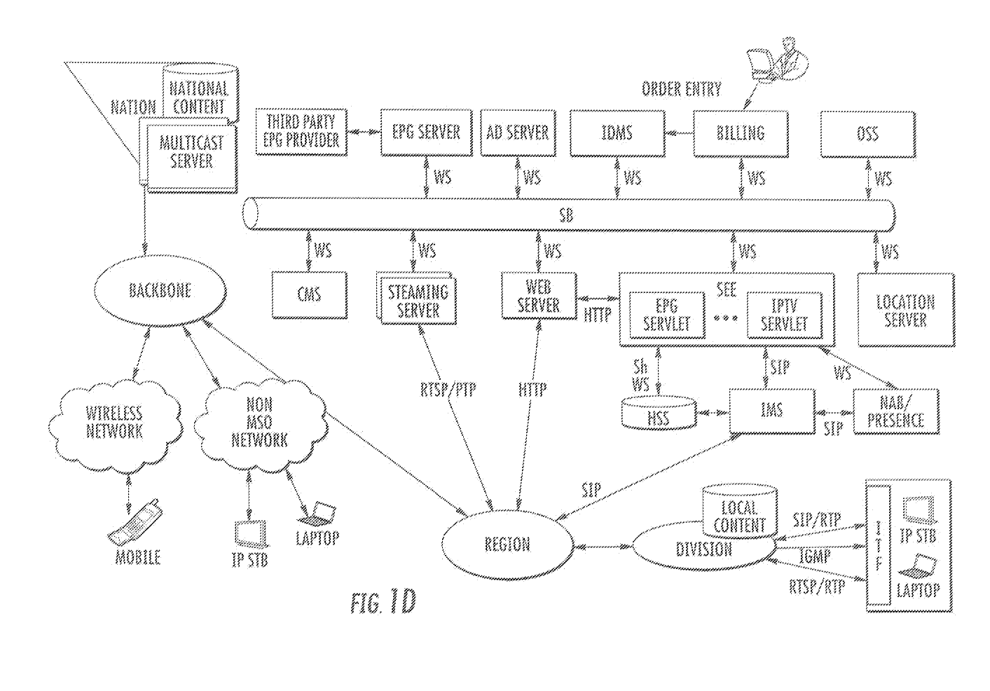

An exemplary resource contention network architecture is illustrated in FIG. 2. The architecture leverages the fact that most national video content providers (e.g., Discovery Channel, FX, The Food Network, etc.) provide one video feed that contains programming intended for both the east coast (Eastern Time Zone) and the west coast (Pacific Time Zone), especially during the prime time hours (8-11 pm). This same feed is often also used for Central and Mountain Times Zones (with appropriate delays to match time zone requirements). In another variant, the content sources provide multiple feeds that are already time shifted (e.g., an east coast feed, a west coast feed, etc.); however, it is becoming more common for MSOs to carry both the east coast and the west coast feed on adjacent channels. As a result, the same programming is often repeated on a three hour delay, either on the same channel or on adjacent channels.

As shown, the network architecture of FIG. 2 generally comprises a content source 103 which provides content to a network server 202. The network server 202 (in cooperation with other network entities, not shown) provides multiplexed content streams to subscribers via a content distribution network 101. Content is provided to subscribers within a multi-program transport stream (MPTS) according to a network pre-determined schedule. In one embodiment, the schedule is also provided to the subscribers devices (CPE 106), such as in the form of a modified electronic program guide (EPG) having program identifiers (PID) which are used to enable searching for repeated programs (as discussed elsewhere herein). The EPG or other schedule of content having searchable PID is delivered to the CPE 106 using the existing distribution network 101.

As shown in FIG. 2, a particular subscriber may have one or more devices associated to his/her account which is linked to a particular premises or subscriber account. In FIG. 2, Premises 1 includes a manager device 107, and several consumer devices or CPE 106 in communication therewith. The manager 107 is configured to run at least one manager application 204 thereon, which manages the tuner resources of each of the connected CPE 106, as well as any resources of the manager 107 on which is installed. The manager application 204 may be downloaded from the network 101, or pre-installed on the manager prior to purchase or rental thereof by a consumer. The manager application 204, as will be discussed in greater detail elsewhere herein, is in one implementation configured to enable alternative delivery of conflicting content by searching for the same content being delivered at another time and/or date, and rescheduling delivery of the requested content at a non-contentious time (or via a non-contended delivery modality).

In one particular embodiment, the manager application 204 uses the previously discussed time shift to resolve resource contention. In other words, the manager application 204 is able to identify, when a conflict arises, whether one or more programs in conflict can be shifted to the alternate time (e.g., either 3 hours earlier or 3 hours later). As noted elsewhere herein, the alternate delivery shift can be performed either automatically, or by prompting the user to make a selection from among alternative delivery options. In the instance the shift is automatic, one or more predetermined rules may be utilized for determining which of at least two conflicting programs should be rescheduled. The rules may be entered manually by a network operator or by a subscriber, may be “learned” based on a particular premises or subscriber behavior, and/or may be based on prevailing network conditions or other internal/external inputs.

As shown, in Premises 1, the CPE 106 each request content from the network 101 either via the manager 107 or directly. The manager application 204 may identify when a request for content (including a request to schedule a recording) conflicts with other scheduled recordings or events, such that e.g., not enough tuner or other resources will be available to meet service all of the outstanding requests. The manager application 204 is then able to perform a search of a schedule for the broadcast of content to determine another instance of that same content within a specified window of time. For example, the application 204 may search within the 24 hour period immediately following the time of the requested content for all other instances of that same content being made available. In another example, the window may be a number of days (e.g., a week).

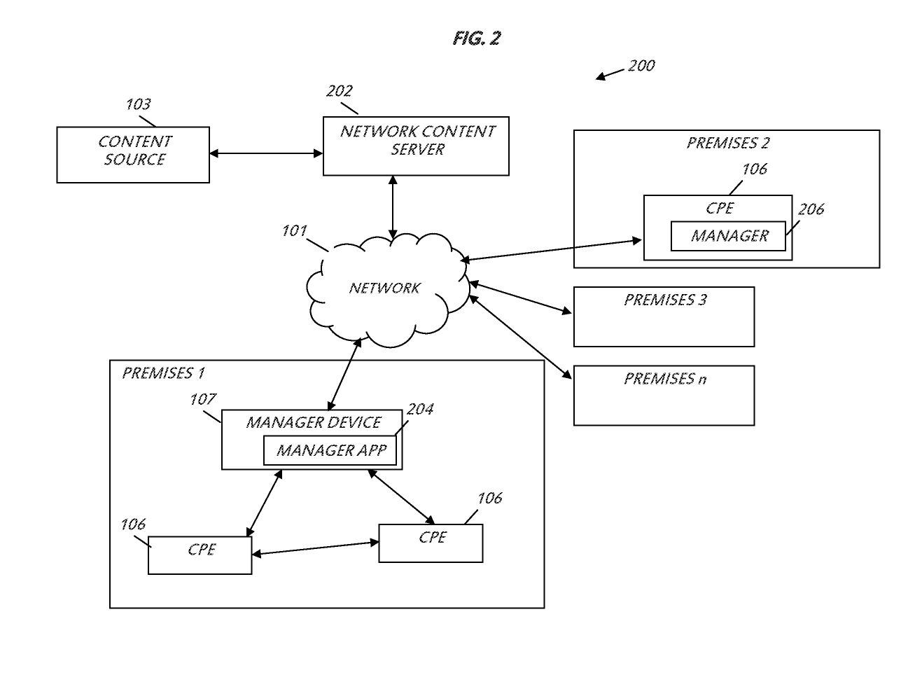

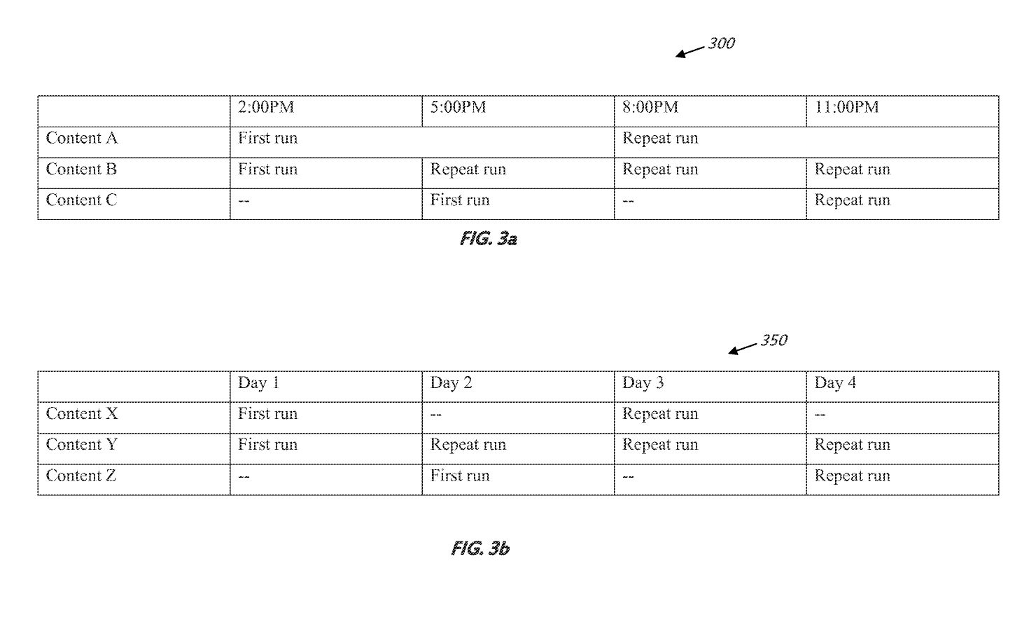

The manager application 204 is able to use information relating to the scheduled delivery of content to identify the most effective means for providing the requested content with the smallest possible delay in the instance of a conflict. For example, FIG. 3a illustrates an exemplary schedule for Content A, Content B, and Content C during a two-hour window. As shown, Content A and Content B are both first run at 8:00. In the instance only a single tuner resource is available, and a subscriber has requested both Content A and Content B, the manager application 204 will review the schedule 300 and determine that Content A is a one-hour program that will repeat at 9:00, whereas Content B is a half-hour program that will repeat at 8:30, 9:00, and 9:30. Hence, the manager application 204 is able to determine that if Content A is made immediately available to the customer, Content B can be made available with only a 30-minute delay. If the manager application 204 instead were to elect to make Content B immediately available, the customer would have to wait an additional hour (i.e., until 9:00) before Content A may be made available again.

FIG. 3b illustrates a similar schedule 350 for content which repeats over a larger window (i.e., daily for Content Y, and every other day for Content X and Content Z). In the embodiment of FIG. 3b, the resource manager application 204 performs similarly to that discussed above, in that it is able to scan the schedule and identify the most efficient rescheduling options. For example, in the instance that only a single tuner is available, and Content X and Content Y are each requested, the manager may identify that the most efficient means for providing both would be to immediately provide Content X, and then provide Content Y with a 1 day delay.

Although the examples listed above utilize a delayed or shifted delivery due which takes advantage of a time zone change that favors the subscriber (i.e., a time zone difference in which requested content is delivered at least an hour later due to a time zone difference), the foregoing principles may be applied in time zones that do not favor the subscriber. Specifically, subscribers in the Eastern Time Zone may have access to resolution of both on-the-fly conflicts (i.e., immediate requests for conflicting content) and future conflicts (i.e., conflicts determined to exist with respect to some future date/time). Subscribers in the Pacific Time Zone may have access only to resolution of future conflicts; in other words, the system must identify the conflict ahead of time, and shift one or more conflicting requests to an earlier delivery (e.g., Eastern Time Zone feed).

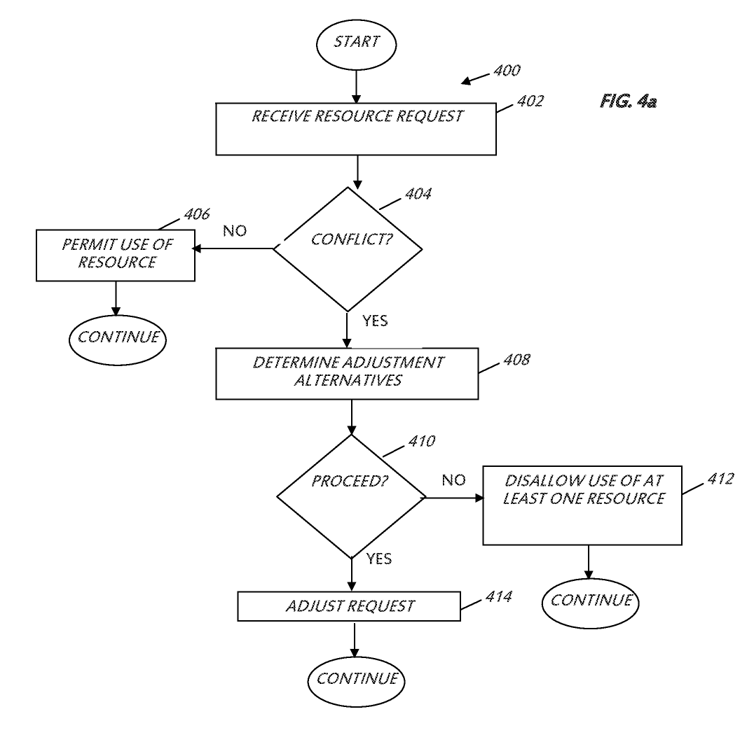

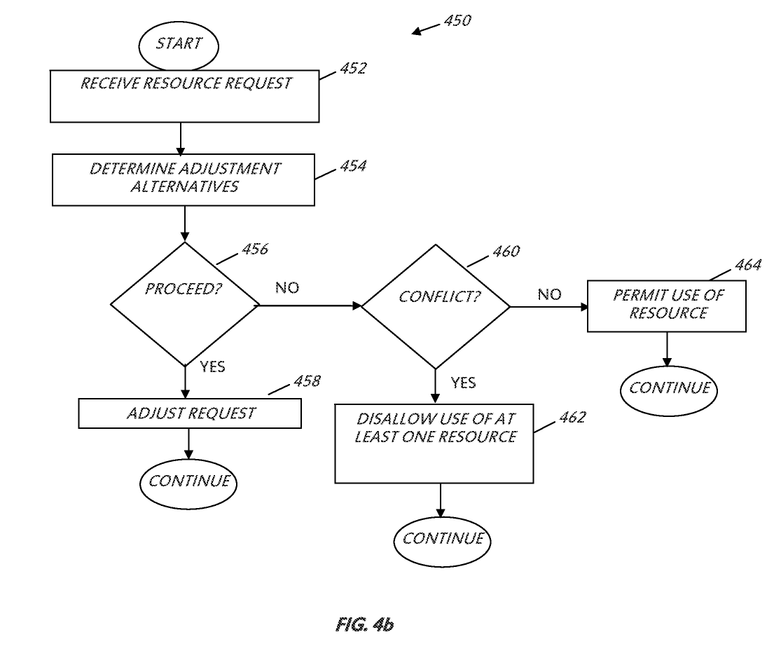

It is appreciated that resource contention issues may be additionally or alternatively resolved by utilizing the manager application 204 to push requests for content to other devices within the user's premises or network. That is to say, when it is determined that a particular client device 106 does not have enough tuner or other resources to service pending requests, the manager entity 107 determine whether other (tuner) resources in the premises or network (i.e., associated to the same subscriber) may be used to service the request. For example, the apparatus and methods of co-owned, co-pending U.S. Patent Application Publication No. 2009/0210912 entitled “MULTI-STREAM PREMISES APPARATUS AND METHODS FOR USE IN A CONTENT-BASED NETWORK” filed on Feb. 19, 2008, and incorporated herein by reference in its entirety may be utilized in conjunction with the present disclosure. As discussed therein, a management entity (such as e.g., manger 107) communicates with multiple tuner resources and other CPE assets in a subscriber premises. The manager receives information from the tuners as to their status, availability, etc., and utilizes this information to reserve at least one of the tuners. The resource manager enables the reserved tuner and CPE to deliver multiple available single transports streams (SPTSs) to various connected receiving, storage, or distribution apparatus within the premises from a single multiplexed input stream (MPTS) transmitted from the headend or hub. The resource manager is able to manage all of the RF source carrier frequencies (e.g., “QAMs”) entering the device, including both in-band and out-of-band channels as well as the resources of other connected devices. It is only when all of the tuner resources of all of the connected devices are being utilized for the delivery of other content at the time of the requested content that the manager application 204 proceeds to reschedule requested content according to the methods disclosed herein (see e.g., FIG. 4a).

Referring back to FIG. 2, at Premises 2, the client device 106 is configured to run a client manager application 206 thereon. The client manager 206 functions in a similar to the manager application 204 running on the manager device 107 disclosed above. However, rather than managing the tuner resources of a plurality of connected devices, the exemplary embodiment of the client manager 206 is simplified to only manage the resources of the device on which it is installed and running. As discussed above with respect to the manger application 204 of the manager device 107, the manager application 206 may be downloaded from the network 101, loaded via another medium (such as a CD-ROM or USB/flash device), or pre-installed on the CPE prior to purchase or rental thereof by a consumer. As occurs on the manager device 107, the manager application 206 is configured to identify and schedule alternative delivery of content when a resource contention issue arises based on a repetition of the requested content in a broadcast schedule (as discussed herein below).

Various other subscriber accounts and premises architectures (such as Premises 3, Premises n as illustrated) may be used consistent with the present disclosure.

Methods for the utilization of the architecture of FIG. 2 to resolve resource contention consistent with the present disclosure will be discussed in greater detail below.

### EXEMPLARY METHODOLOGY

Referring now to FIG. 4a, an exemplary embodiment of a method 400 for resolving resource contention issues according to the disclosure is shown.

Per step 402, a request for use of a resource is transmitted. In one embodiment, the request may be received from a subscriber at the manager device 107, or at a CPE 106 (either connected to a manager device 107, or served without the use of a separate manager entity). In yet another embodiment, the request may be made on behalf of another device (e.g., as a proxy), or to request access to the tuner resources of another device. For example, a first device may request use of resource associated with a second device for content to be utilized at the second device, or the first device may request to use a resource associated with a second device for content to be utilized at the first device.

Next, per step 404, it is determined whether the requested use would conflict with previously scheduled use and/or current or existing use of the available resources. The conflict may be determined at e.g., a management entity 107 or at the CPE 106 which made the request (and then a notification optionally transmitted to a management entity 107). In other words, it is determined whether the requested use exceeds the number of available resources the time to which the request pertains. If no conflict exists, the use is permitted (step 406). If a conflict exists, adjustment alternatives are determined (step 408). As noted above, the exemplary embodiment of the manager application 204 or 206 determines adjustment alternatives by reviewing a schedule for the broadcast of content, to find instances where one or more of requested program streams are repeated.

The mechanics for determining alternative delivery options depend on the metadata available for the requested programming and its accuracy. In one particular embodiment, the manager application 204 or 206 searches for other instances of the same program (i.e., same show and episode where appropriate) within a time window such as e.g., 7 days, and suggests alternate recording times. In another embodiment, the application 204 or 206 reviews a 3 hour window before and after the stated time of the requested program for duplicate program listings, either on the same channel or on adjacent channels.

In yet another embodiment, the application 204 or 206 may simply force a 3 hour time shift (either before or after the stated time of the conflicting request) without confirming that a repeat of the content is scheduled within this window. Additionally, or in the alternative, the application 204 or 206 may search other available programming sources (such as e.g., video on demand, streaming video, and internet sources, etc.) for the requested content; if a suitable alternative is found, the tuner requested content will be provided from the identified source as soon as a tuner resource is available for delivery thereof. Other mechanisms for determining alternate delivery paradigms will be discussed in greater detail below.

In one particular embodiment, the manager application 204 or 206 derives the direction in which programming may be shifted (i.e., forward or backward from the originally designated time) based on what time zone or location it is currently configured to operate in (e.g., eastern and central will see +3 hour time shift. Mountain and Pacific will see −3 hour time shift). In this manner, the application 204 or 206 is programmed to understand the relationship between adjacent channels when they are time shifted but otherwise identical in the content being delivered. Thus, when a subscriber identifies a program to record or display at some future time, the system may, upon determining a conflict, automatically shift the request or automatically determine alternate delivery dates/times.

Per step 410, it is determined whether the system should proceed according to a determined adjustment alternative. The decision of whether to proceed may be determined based on a set of pre-entered or user-entered rules for making such adjustments. For instance, the user may provide input in the form of interactive selection or default settings identifying the desired window for scheduling alternative delivery. For example, the user may indicate that the requested program must be recorded same day, or same week as the originally scheduled program. The manager application 204 or 206 uses the user input information to decide which programs to record as scheduled and which to shift. Additionally, the absence or presence of a repetition of certain content is used to further prioritize how resources will be allocated (i.e., which requests will be serviced immediately and which will be shifted).

In one further variant, the manager application 204 or 206 may be further equipped to “learn” a user's preferences. For instance, if certain programs are notably selected by the subscriber for immediate delivery (despite it being more efficient to shift delivery of these), the application may conclude that the particular programs are highest priority to the subscriber. In another example, if other ones of the requested programs are notably selected by the subscriber for delayed delivery (despite it being more efficient to provide them immediately), the application may conclude that the particular programs are lowest priority to the subscriber.

The application may be further configured to identify programs which are scheduled for e.g., recording which the user never or seldom actually watches or completes playback; the system can therefore conclude that the programs are of lowest priority when a resource contention issue arises. In one implementation, the apparatus and methods of co-owned, co-pending U.S. patent application Ser. No. 12/414,576 filed on Mar. 30, 2009 and entitled “RECOMMENDATION ENGINE APPARATUS AND METHODS”, which is incorporated herein by reference in its entirety, are utilized. As discussed therein, a mechanism is provided which is configured to learn (and unlearn) the user's preferences based on actions taken with regard to content.

Rules for assigning certain requests to a shifted or delayed delivery may also be based on network conditions and/or pre-determined by a network entity. For example, a constrained network may prioritize delivery of content for which other requests within the service area also exist over those for which no other requests currently exist. In another embodiment, a rule may be set to never prioritize delivery of content which is marked as concurrently being recorded at a network entity. For instance, certain content may be identified as so-called “start over” and “look back” content. The identified content (as well as other types of network PVR content) is always set to be recorded at a network entity at a first instance of availability thereof (including a network hub or edge device). Hence, the system may place requests for the identified content as lowest in priority as dedicating resources to that particular content may be an inefficient use of premises resources.

When a conflict is encountered and a possible delivery alternative identified, the system notifies the user in one embodiment to determine whether to proceed to enable the shifted delivery paradigm. In one variant, the apparatus and methods of co-owned, co-pending U.S. Patent Application Publication No. 2008/0192820 entitled “METHODS AND APPARATUS FOR CONTENT DELIVERY NOTIFICATION AND MANAGEMENT” and filed on Feb. 14, 2007, incorporated herein by reference in its entirety, may be utilized in conjunction with the present disclosure to provide such notification. As discussed therein, notifications are sent to subscribers to alert them of a potential unavailability of requested content (i.e., of a conflict). The subscriber may be offered the choice to either cancel the request or to accept alternative delivery of the requested content (as discussed herein). The subscribers may be further provided with the date and time of the alternate delivery, may be allowed to specify a date and/or time for delivery (from among the multiple delivery alternatives determined from a schedule), such as one convenient to them, and may be provided with a “content ready” notification when the content is actually ready for delivery.

When it is determined that the system cannot proceed with a shifted delivery alternative, either because none exists or because doing so would violate a pre-set or user-entered rule or prioritization, the use of the requested resource is denied (step 412). When the system can proceed with a shifted delivery alternative, an appropriate alternative is selected and one or more resource requests are adjusted accordingly (step 414). As noted above, selection of an alternative delivery mode may be performed automatically (such as by the manager 107) or manually by a user (such as upon notification and selection of an alternate delivery option).

The method 400 of FIG. 4a is useful for example when a newly entered request (for immediate content or recording/scheduling delivery of future content) is determined to be in conflict with existing use or schedule future use. However, the present disclosure may be further implemented to ensure immediate delivery of content and to schedule delivery of future content according to the most efficient means despite the existence of an actual conflict (as illustrated in FIG. 4b).

FIG. 4b illustrates an exemplary method 450 for efficient delivery of content utilizing an alternate delivery scheme. Per step 452, a request for utilization of a resource is received. As indicated above with respect to FIG. 4a, requests may be received at a manager 107 or CPE 106 device. Immediately upon receiving the resource request, the manager application 204 or 206 is triggered to determine whether alternate (or shifted) delivery of the requested content is available (step 454). That is, even though no conflict has yet been determined to exist, the system automatically identifies other delivery schemes (which may be more efficient when viewed in light of additional requests received subsequent to the current request). The mechanisms by which the manager application 204 or 206 determines adjustment alternatives are similar to those discussed above with respect to FIG. 4a; i.e., the application reviews a schedule for the broadcast of content to find instances where one or more of requested program streams are repeated.

In one embodiment, the method 450 halts once the adjustment alternatives are determined. Information relating the content to one or more alternative delivery dates/times, locations (i.e., network PVR, on-demand, etc.) is stored at e.g., the manager 107 or the device 106. Subsequently, when a conflict is determined, the manager application 204 or 206 utilizes the stored information to determine whether to provide alternate delivery of one or more of the requested content (similar to the methods disclosed above with respect to FIG. 4a).

Returning to the method of FIG. 4b, per step 456, the application 204 or 206 determines whether to implement a shifted delivery such as by notifying the subscriber and/or applying one or more user-entered or pre-set rules for determining when to proceed. Per step 458, if the system is allowed to proceed, the resource request is shifted. Per step 460, if the system is not allowed to proceed, it must then be determined whether an actual conflict arises.

The presence of a conflict at this stage (i.e., after it is determined that the request cannot be shifted) results in an automatic denial of service of the request (step 462). However, if no conflict arises, then the request may be serviced (step 464).

### Additional Delivery Mechanisms—

Alternate delivery options, as discussed above, may be determined based on e.g., a predetermined schedule indicating repeated delivery of requested content provided on the same program and/or user channel, or provided on a separate program and/or user channel at a different date/time than was requested.

In another embodiment, the system may be configured to, in addition to or as an alternative to searching the predetermined delivery schedule, search for the requested content among previously stored video on demand (VOD) content. Still further, the system may identify content which is set to broadcast at a future date/time, and which will be stored and maintained at a VOD server at that future time. Accordingly, the system may further determine whether one or more conflicting content requests comprises a request for content that is scheduled to be available via VOD at or after the requested date/time.

In another embodiment, when it is determined that there are insufficient resources to meet the demands, requested content is stored by the network at an on-demand (e.g., VOD) server. The stored content may be collected from the original broadcast date/time, or from a shifted date/time, as discussed above. The stored content is identified as only being useable by the requesting premises (e.g., Premises A of FIG. 2 above). In one embodiment, this process may be performed via a device or subscriber specific encryption, or otherwise ensuring that the stored content is only distributed to authorized devices (i.e., devices within the identified premises). A notification is sent from the manager application 204 or 206 to the network when resources are available at the premises to receive the content. In this manner, manager application 204 or 206 determines the delay for the alternate delivery of requested content, as opposed to a network predetermined schedule. Storage of the content at a VOD or other network server may, in one variant, be temporary such that it may, for example, only persist until a date/time determined by the manager application 204 or 206 at which point it is delivered to the premises and erased from network storage.

Further, to resolve resource contention, in one embodiment, VOD bandwidth may be utilized. For example, the system may be configured to switch to QAM that is generally reserved for the delivery of VOD content and hence provide the requested content as VOD to fill-in when resources are constrained. Additionally, requests may be filled via any means that has available bandwidth (such as switched QAM, IP multicast, IP unicast, etc.) in the timeframe during which the content is requested.

In yet another embodiment, a rule may be established within the system to, in the instance of a conflict, always prioritize “popular” content, content which is provided as a multicast, or content which is already provided in a BSA network (i.e., for which a switch will not be required). That is to say, if the system identifies content which is most efficient to deliver, because it is concurrently delivered to other subscribers in the local network, it will prioritize delivery of that content over other requested content in the instance there is a resource contention issue. Content which is not “popular”, multicast, and/or currently switched into delivery is pushed to an alternate delivery mechanism as discussed elsewhere herein. In one further variant, the manager application 204 or 206 may store information relating to pending requests for content. As additional requests are received, the manager 204 or 206 may determine that a particular program has attained a status which qualifies it for prioritization (such as e.g., has a number of requests which meets a predetermined threshold to be considered “popular” content, to be added to a multicast, and/or to be switched into delivery). The information can then be subsequently used to apply the new prioritization scheme with respect to this content to previously received requests for the content which may have been selected for adjusted delivery (because the content had not yet attained the status at the time the request was made). Additionally, the new prioritization scheme may be applied to newly received requests for the identified content.

Popularity of a given content channel may be adjusted by time of day, day of the week, etc., such as through use of the methods and/or apparatus discussed in co-owned, co-pending U.S. patent application Ser. No. 13/843,322 filed on Mar. 15, 2013 and entitled “APPARATUS AND METHODS FOR DELIVERY OF MULTICAST AND UNICAST CONTENT IN A CONTENT DELIVERY NETWORK”, which is incorporated herein by reference in its entirety. As discussed therein, the network may identify e.g., CNN as a “popular” channel. However, the popularity of the programming on CNN may vary throughout the day. Hence, instead of constantly prioritizing the contents of the particular channel, CNN, the prioritization may be relegated to only those times when it is popular. Hence, if CNN is only popular between 6-8 am and 5-6 pm, requests for CNN programs to air during those times will be prioritized. Additionally or alternatively, prioritization may be based on the type of programming. For example, live events (e.g., sports, award shows, etc.) may be prioritized over pre-recorded content. Such live events may be flagged as such in the programming metadata to ease identification thereof.

It is further noted that, in one embodiment, when a network entity determines that content should be provided in a broadcast, multicast and/or otherwise switched into delivery via an edge switch device, the manager application 204 or 206 is notified. In this manner, when a particular device 107 requests particular IP packetized content, the request is evaluated by the manager application 204 or 206. The manager application 204 or 206 evaluates the request against a known set of available multicast (or broadcast, etc) IP streams for the date/time of the requested content and makes a determination as to whether a prioritization of the content would be more efficient than providing alternative delivery thereof in the instance of a conflict (i.e., determines whether providing the content would include joining an existing multicast, or would involve establishing a new unicast delivery session). For the on-demand multi-access delivery methods (switched QAM, IP VOD with a multicast component), further economies may be had by coordinating second-chance recipients who can see the same multi-access delivery method. In other words, among the known set of available streams for the date and time of the requested content, the system may add other pre-scheduled de-conflict delivery events.

It is further appreciated that, in one variant, the system may additionally substitute different types of content for a requested content. For example, a user request may be for standard definition (SD) format, yet may be serviced with high definition (HD) content, or vice versa. Alternatively, IP content may be provided though a request was sent for non-IP content (in the instance the requesting device is configured to utilize IP content). In yet another variant, the system may provide content of a different codec than that requested. Such a mechanism may further take into account network constraints or conditions when electing which content variant to provide.

### Manager Device—

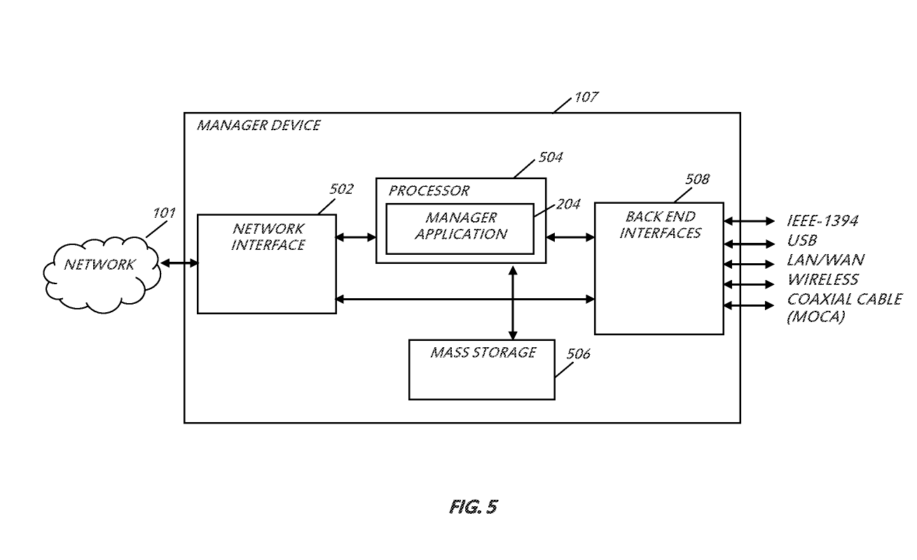

Referring now to FIG. 5, one exemplary embodiment of the manager device 107 is illustrated. As shown, the manager device 107 comprises a network interface 502, processor 504, mass storage 506, and backend interfaces 508.

The network interface 502 in one embodiment comprises a cable modem, such as e.g., a DOCSIS 3.0 compliant cable modem of the type discussed in “DOCSIS® 3.0 Management Features Differences Technical Report” CM-TR-MGMTv3.0-DIFF-V01-071228 and “DOCSIS 3.0 OSSI Configuration Management Technical Report” CM-TR-OSSIv3.0-CM-V01-080926, each of which is incorporated herein by reference in its entirety. The cable modem provides DOCSIS connectivity to the CPE 106 to be used for communication of the CPE 106 to the network 101, as well as various other purposes (such as VOD, Internet “surfing”, interactive program guide (IPG) operation, etc.). In an alternative embodiment, the CPE 106 may communicate directly with the headend or other entities.

The network interface 502 of the manager device 107 further comprises one or more QAM tuners configured to receive content from the managed network 101. The RF tuner(s) may comprise for instance traditional video RF tuner(s) adapted to receive video signals over, e.g., a QAM. For example, the RF tuner(s) may comprise one or more tuners, a demodulator, decryption module, and demultiplexer of the type well known in the art, although other configurations may be used. The QAM tuners utilized in the manager device 107, as noted above, may be utilized toward an overall number of available resources in the premises (i.e., all of the device in the premises may share resources as noted above).

In another variant, the manager 107 may include a wide band tuner, such as that discussed in co-owned, co-pending U.S. Patent Application Publication No. 2006/0130113 entitled “METHOD AND APPARATUS FOR WIDEBAND DISTRIBUTION OF CONTENT” and filed Dec. 14, 2004, incorporated herein by reference in its entirety. The wideband tuner arrangement enables the manager 107 to receive content associated with one or more program streams distributed across two or more QAMs. Additionally, the RF tuner(s) may incorporate functionality to modulate, encrypt/multiplex as required, and transmit digital information for receipt by upstream entities such as the CMTS. The tuners may additionally be capable of tuning across the entire band of QAM channels such as those developed by e.g., Texas Instruments and Broadcom.

The manager device 107 can assume literally any discrete form factor, including those adapted for set top/desktop, hand-held, or wall-mounted use, or alternatively may be integrated in whole or part (e.g., on a common functional basis) with other devices (such as the CPE 106) if desired. Additionally, the manager device 107 may include other elements and interfaces such as for example an interface for the HomePlug A/V standard which transmits digital data over power lines. WiFi capability, a PAN (e.g., 802.15), Bluetooth, or other short-range wireless interface for localized data communication, etc.

The processor 504 is configured to run a resource management application 204 of the type discussed elsewhere herein. The manager application 204 software enables the manager 107 to perform the evaluation, decision-making, processing, and manipulation required to shift a request for a resource (as discussed above with respect to FIGS. 4a and 4b). In one variant, the manager application 204 receives requests from various devices in communication therewith, receives scheduling metadata relating to available programming, determines actual conflicts, identifies possible delivery alternatives, notifies a user of the conflict and the alternatives, applies one or more user-input or network predetermined rules for enabling shifted delivery, and manages its own tuner resources as well as those of other devices connected thereto.

Communication between the manager 107 and the client devices 106 occurs via the backend interfaces 508. Such communication may utilize e.g., IEEE 1394, USB, LAN/WAN, wireless, and/or MOCA communications protocol with equal success.

In another specific embodiment, the manager apparatus 107 may be of the type discussed in co-owned, co-pending U.S. Patent Application Publication No. 2011/0093900 filed on Oct. 20, 2009 and entitled “GATEWAY APPARATUS AND METHODS FOR DIGITAL CONTENT DELIVERY IN A NETWORK”, which is incorporated herein by reference in its entirety. As discussed therein, internet (or IP packetized) content is de-encapsulated from a first media file container format and subsequently re-encapsulating to a second media file container format which is compatible with one or more receiving devices. For example, content which is delivered from a host server may be encapsulated in e.g., MP4, if the receiving client device(s) are not capable of reading the MP4 files, the gateway may re-encapsulate to e.g., MPEG-2 or other format that the receiving device is capable of reading. The manager device 107 may process received content automatically into various alternative encapsulation formats or, may encapsulate as needed to the format of the specific requesting device. The processed content may also be stored at the manager 107 or other data storage (whether at the premises or network) for future use for transmission to other client devices requesting the same content in the particular new format. In this manner, the manager 107 may leverage a delivery of requested content in IP format to services requests from legacy devices for non-IP content, including a shifted delivery of the IP format content.

### Exemplary User Device—

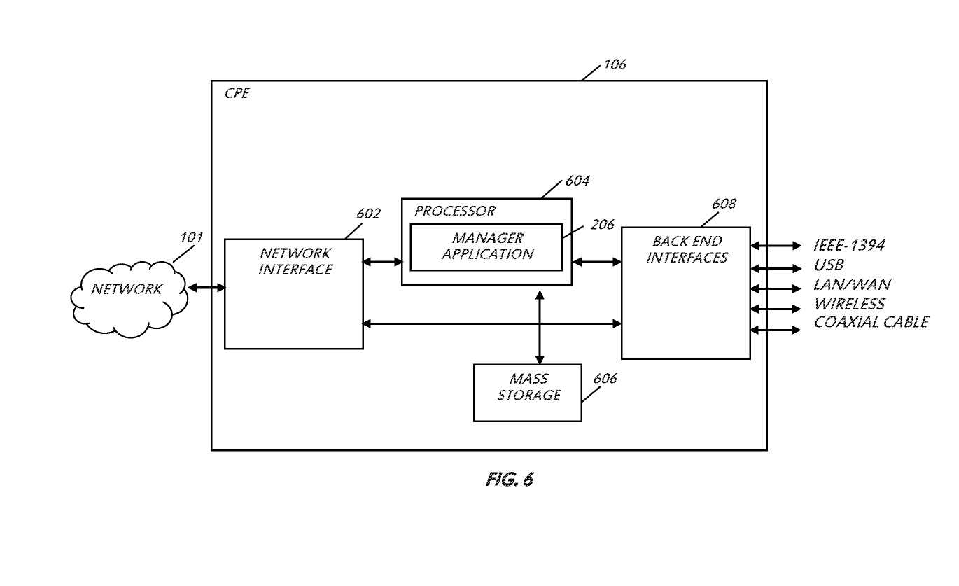

An exemplary user device (or CPE) 106 useful with the present disclosure is illustrated in FIG. 6. The CPE 107 may comprise for instance any device capable of requesting, receiving, and/or decoding content, whether for display thereon, or for recording, display, or storage on a device in communication therewith. Exemplary devices include set top boxes, television sets, laptop and desktop computers, and even cellular smartphones, personal media devices (PMD), etc. In one exemplary embodiment, the IP-capable CPE 106 is compatible with Digital Living Network Alliance (DLNA) standards for consumer electronics (such as those discussed in DLNA Interoperability Guidelines, version 1.5, published March 2006 (expanded October 2006), which is incorporated herein by reference in its entirety) for signaling purposes, and also makes use of a digital rights management (DRM) content protection scheme to comply with limitations on certain content, or provide authorization credentials with respect to protected content.

As shown in FIG. 6, the CPE 106 generally includes e.g., a network interface 602, a processor 604 and associated storage 606, and optionally a plurality of back end interfaces 608 for communication with other devices.

The network interface 602 enables communication between the CPE 106 and the network 101 (and/or manager 107). One or more of the backend interfaces 608 are used for communication with other linked devices. In one embodiment, the backend interface 608 (and not the network interface 602) is used for communication between the CPE 106 and the manager 107.

The CPE 106 processor 704 is configured to run a manager application 206 in the illustrated embodiment, however, alternative embodiments may utilize a manager application running only on the manager apparatus 107. The manager application 206 is in the exemplary implementation a computer program which enables the CPE 106 to perform the evaluation, decision-making, processing, and manipulation required to shift a request for a resource (as discussed above with respect to FIGS. 4a and 4b). In one variant, the manager application 206 receives scheduling metadata relating to available programming, determines actual conflicts with requested content, identifies possible delivery alternatives, notifies a user of the conflict and the alternatives, and applies one or more user-input or network predetermined rules for enabling shifted delivery.

In yet another embodiment, the CPE 106 further comprises a hard drive in communication therewith or integrated therein which acts as a digital video recorder (not shown).

Many other approaches and combinations of various operational and business paradigms are envisaged consistent with the present disclosure, as will be recognized by those of ordinary skill when provided this disclosure.

It will be recognized that while certain aspects of the present disclosure are described in terms of a specific sequence of steps of a method, these descriptions are only illustrative of the broader methods, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the ideas set forth herein. The foregoing description is of the best mode presently contemplated of carrying out the disclosure. This description is in no way meant to be limiting, but rather should be taken as illustrative of the general principles of. The scope of the disclosure should be determined with reference to the claims.

What is claimed is:

1. A method of resolving resource contention within a user sub-system of a content delivery network, said method comprising:
receiving a request for content from a user, said content scheduled for delivery from said network at a first time;
determining whether sufficient resources will be available in said user sub-system at said first time for to service said request; and
when it is determined that sufficient resources will not be available at said first time:
identifying one or more second times at which said content is scheduled for delivery from said network; and
enabling said request for said content at one of said one or more second times.

2. The method of claim 1, further comprising evaluating said one or more second times given a plurality of rules, a result of said evaluation indicating whether said user sub-system may proceed to enable said request for said content at said one of said one or more second times.

3. The method of claim 2, wherein said plurality of rules are stored within said user sub-system by at least one of:
an entity of said network; and
said user.

4. The method of claim 2, wherein said act of enabling said request for said content at one of said one or more second times comprises an automatic delivery of said content at said one of said one or more second times based at least in part on said act of evaluating given said plurality of rules.

5. The method of claim 2, further comprising notifying said user when said evaluation indicates that said user sub-system may proceed to enable said request for said content at said one of said one or more second times.

6. The method of claim 2, wherein said plurality of rules are extracted from a plurality of data collected relating to said user's interaction with previously delivered content.

7. The method of claim 2, wherein when it is determined that said user sub-system may not proceed to enable said request for said content at said one of said one or more second times, said method further comprising cancelling said request.

8. The method of claim 1, further comprising enabling said user to select said one of said one or more second times from among said identified one or more second times at which said content is scheduled for delivery from said network.

9. The method of claim 1, further comprising notifying said user when it is determined that sufficient resources will not be available.

10. An apparatus for resolving resource contention in a content delivery network, said apparatus comprising:
a first interface configured to receive content from said content delivery network;
a second interface configured to communicate with a plurality of subscriber devices;
a storage apparatus; and
a processor configured to execute at least one computer program, said computer program comprising a plurality of instructions which are configured to, when executed:
receive a request for content from a first subscriber device;
determine that said request conflicts with pending requests from other ones of said plurality of subscriber devices; and
based at least in part on the determination, service at least one of said request and said pending requests at a second time;
wherein said second time is determined based at least in part on a schedule configured to indicate a repetition of delivery of said content within a pre-determined time window.

11. The apparatus of claim 10, wherein said determination of whether said request conflicts with said pending requests from said other ones of said plurality of subscriber devices comprises an evaluation of a date, time, and duration of each of said request and said pending requests, and a number of available tuner resources.

12. The apparatus of claim 10, wherein a decision of which of said at least one of said request and said pending requests is based at least in part on a plurality of subscriber-entered rules.

13. The apparatus of claim 10, wherein said determination of whether said request conflicts with pending requests from other ones of said plurality of subscriber devices comprises a determination that a number of available tuner resources of each of said plurality of subscriber devices and said apparatus is less than a number of tuner resources needed to service said pending requests and said request.

14. The apparatus of claim 10, wherein a decision of which of said at least one of said request and said pending requests is based at least in part on a plurality of data relating to subscriber interaction with prior content.

15. The apparatus of claim 14, wherein said prior content comprises content related to said requested content in at least one respect.

16. A computer readable apparatus having a storage medium comprising a plurality of instructions which are configured to, when executed:
receive a request for first content from a subscriber device;
determine a date and time for a first scheduled delivery of said first content;
determine a number of pending requests for second content at said date and time;
when it is determined that a number of resources necessary to service said request for said first content and said pending requests for said second content is greater than a number of resources available, evaluate a content delivery schedule, said content delivery schedule indicating a plurality of dates and times for a second scheduled delivery of at least one of said first and said second content;
identify one of said plurality of dates and times for a second scheduled delivery of at least one of said first and second content via said evaluation; and
enable an alternate delivery of at least one of said first and second content at said second scheduled delivery time.

17. The apparatus of claim 16, wherein said alternate delivery further comprises a determination of which of said first and second content is selected for said alternate delivery based at least in part on a plurality of user-entered rules.

18. The apparatus of claim 16, wherein said alternate delivery further comprises a determination of which of said first and second content is selected for said alternate delivery based at least in part on a plurality of historical data relating to a user's interaction with third content.

19. The apparatus of claim 18, wherein said third content is related in one or more respects to at least one of said first and second content.

20. The apparatus of claim 16, wherein said plurality of instructions are further configured to, when executed, provide a notification to a user of said subscriber device indicating said alternate delivery.
